(19) United States
(12) Patent Application Publication
(10) Pub. No.: US 2004/0086086 A1
(43) Pub. Date: May 6, 2004

(54) Automated subscriber loop identification and data transfer for subscriber loop testing

(76) Inventors: Myron C. Butler, Edmond, OK (US); Carl P. Bright, Harrah, OK (US)

Correspondence Address: MCAFEE & TAFT, TENTH FLOOR, TWO LEADERSHIP SQUARE, 211 NORTH ROBINSON, OKLAHOMA CITY, OK, 73102, US

(21) Appl. No.: 10/284,012

(22) Filed: Oct. 30, 2002

(51) Int. Cl. H04M 1/24; H04M 3/22; H04M 3/08

(52) U.S. Cl. 379/9; 379/1.03; 379/22.01

(57) ABSTRACT

A loop responder enables a telephone technician to use a test device to automatically and accurately validate the performance of a telephone subscriber loop from the originating equipment to the subscriber demarcation point without any human assistance at the central office. The directory number for the subscriber loop under test is automatically identified and stored without any human intervention such that a No Test Trunk can be automatically used and test results can be automatically associated with the respective line record information. Data is collected and then transmitted in suitable manner and stored in non-volatile memory for collection by and/or transmission to a central host processing system. Particular aspects of the aforementioned collection and storage processes relate to the transmission of the data packets via several input/output (I/O) ports. Either modem or DTMF communication can occur over the same pair of tip and ring wires.

### BACKGROUND OF THE INVENTION

The invention employs a novel method of identifying a telephone network subscriber loop under test and storing the identifying information. This can be used, for example, to preclude fraudulent reporting practices and to automate the test access circuit of a telephone switching system to provide the means to metallically access the loop under test without any human intervention during the testing process. The present invention also relates to obtaining and transferring the test data. Another aspect pertains to detecting a call and automatically differentiating between modem and DTMF signaling in the call.

A telephone subscriber loop with which the present invention can be used includes two wires, each of which is typically insulated and twisted with the other to define a twisted pair. Typically, multiple pairs are grouped in a cable that has a surrounding outer conductive shield that is connected with earth ground when placed in use.

Such a cable can be used, for example, between a central office and a cross-connect box in a telephone plant distribution system. Another such cable can extend from the cross-connect box into the user territory where individual pairs are routed to respective aerial or buried terminals which in turn are connected to an end user's residence or business via a drop-wire or buried service wire connection. In the United States, the drop-wire is connected to an F.C.C. mandated subscriber loop interface providing a demarcation point between the telephone company-owned facilities and the subscriber-owned facilities. This interface provides telephone company personnel test access while providing both high voltage and sneak current protection to the subscriber's telephone equipment and the subscriber or user. Inside wire is used to make the final connection from the demarcation point to the telephone station equipment.

Each such pair of wires is required by standards set forth by state regulatory agencies and the Federal Communications Commission (F.C.C.) to meet certain characteristics that facilitate clear transmission of voice and data signals. The basic criteria throughout North America establish a range of acceptable levels of loop current, AC and DC voltage, power influence, transmission loss (or insertion loss), metallic noise, longitudinal noise, balance, insulation resistance and capacitance. The overall performance of such a loop from the central office to the subscriber's demarcation point must comply with both state and federal standards. With the advent of digital subscriber line service offerings, the compliance to age-old standards has become more critical as the data rates are ever-increasing. Telephone cable sold in North America is manufactured to strict standards for dielectric constants and capacitance thereby creating predictable performance to include, but not limited to, insertion loss, balance, resistance, bandwidth, immunity to noise, cross-talk and power influence.

Test instruments, referred to as field test devices or units, are available to measure these parameters for testing the quality of an installed subscriber loop. The current trend in test and measurement devices is to consolidate traditional VOM (Volt-Ohm-Milliammeter) functionality with transmission impairment measuring systems (TIMS). Historically portable test sets used by telephone technicians in the field to test individual two-wire subscriber loops of a telephone network have been free-running devices, that is, they are physically transported from one location to another and lack the capability to automatically communicate test data with a centralized line conditioner and/or database. With such equipment, a user observes all measurements and records the results manually. Measurements are subject to private interpretation and human error. Other apparatus, located in associated telephone network central offices for facilitating end-to-end testing measurements, are manually or semi-automatically controlled to terminate or condition the opposite end of the subscriber loop in some prescribed manner to facilitate the measurements by the field test unit required to assess the overall performance of the subscriber loop pair. For example, to effectively test the insertion loss in the voice frequency band, a 1,004 hertz (Hz) sinusoidal tone, transmitted at a level of 0 decibel (dB) must be applied at one end of the cable pair, while a test instrument, equipped with a front-end impedance of 600/750 ohms and capable of measuring this frequency within plus or minus one tenth of a decibel over a dynamic range of 30 dB or greater, is connected to the opposite end of the cable pair section under test. This 1,004 Hz tone source is universally available at central offices in the Public Switched Telephone Network (PST) throughout North America on a dial-up basis. Thus, a test instrument designed to measure circuit loss and further equipped to dial the telephone number assigned to this tone source is capable of measuring the insertion loss of the subscriber loop. This 1,004 Hz tone source is commonly referred to as the Milliwatt Supply in the discipline of telephony. When the dedicated number is dialed, the Milliwatt Supply answers on the arrival of the ringing signal; it then applies a precise 1,004 Hz sinusoidal signal at 0 dB for a fixed period of time. Test sets are available to manually measure this tone level. Current North American standards dictate the acceptable insertion loss to be no greater than 8.0 dB. When this measurement is taken at the customer demarcation facility, this type of transmission measurement is referred to as end-to-end testing.

Another important parameter for assessing the performance of a subscriber loop from the central office to the point of demarcation is insulation resistance. This parameter is commonly referred to as a leakage test and is performed by applying a potential of 100 to 150 volts DC through a current limiting device to calculate the resistance expressed in megohms. The industry standard dictates a minimum acceptable value of this dielectric constant to be >3.3 megohms when measured between the conductors of the pair or from each side to the shield of the cable or ground. This test may only be performed if the central office battery supply is disconnected from the pair under test. The industry standard negative 48-volt battery source may be lifted manually by physically removing the Telephone Line Protector Unit (TLPU) at the central office or by dialing a special number associated with the switch. This feature is known by at least one switch manufacture as the “Silent Switchman.” To remove the battery from the pair under test, the technician places a meter with dialing capabilities across the pair and dials the dedicated number for the Silent Switchman. When the number answers, the battery is lifted off the pair for a predetermined period of time and then the line is restored to service.

In the examples cited above it becomes obvious that certain end-to-end performance testing of the subscriber loop requires specific types of line conditioning on one end, while the measuring is done on the opposite end. While the devices described above afford one-person testing for measuring loss and insulation resistance, other conditioning is required to complete the performance testing process, e.g., a short (commonly referred to as a strap) is required to measure loop resistance and quiet termination or balanced termination is required to measure noise. Prior to the introduction of the Silent Switchman battery disconnecting device or the dial-up milliwatt supply, for example, this process required two persons with one stationed at each end of the subscriber loop; one person measured the parameters while the person on the opposite end provided the line conditioning for each specific test.

In 1980 the Badger Meter Electronics Division introduced the Centra-Line 630/612A Test System employing synthesized speech to guide a field technician through a one-person testing process. In practice, the field technician dialed the central office-based system with a linesman's test set (butt set) and used dual tone multi-frequency (DTMF) signaling to request certain parameters of the subscriber loop to be tested. The system employed synthesized speech to direct the field technician through the testing process and verbalized the results.

Another central office-based device to provide remote control of the central office line conditioning process via a single number dial-up access was designed and sold by Murphy Laboratories under the name BGR or Battery Ground Release circuit (circa 1983).

In late 1983 another method to consolidate the line conditioning and transmission testing into a single number access device was designed and sold by Teradyne under the trade name of 4TEL VRS 400. U.S. Pat. No. 4,139,745, Ashdown et al, describes a methodology to provide metallic access to one of a plurality of subscriber lines associated with a specific switch. It should be noted that this system requires the technician to provide the line conditioning at the far end of the subscriber loop, under synthesized voice direction from a centralized testing system at the central office.

In 1986, Pierce et al, U.S. Pat. No. 4,670,898 and again in 1989, Chan et al, U.S. Pat. No. 4,841,560 taught a method of direct access to a device mounted in the central office to provide a precise tone source, disconnect the battery from a subscriber line under test, and provide other line conditioning functions. A manual method of remotely controlling the line conditioning process through the use of DTMF signaling and synthesized voice responses permits a technician equipped with a telephone linesman's test set (butt set), or equivalent device, to control the central office-based unit, thereby affording a field technician the ability to manually make electrical measurements of the subscriber loop without any assistance at the central office.

Yet another device, introduced in 1986 from Nortel and sold under the trade name Nortel Local Test Cabinet Model 3703/3713, provides line conditioning at the central office and provides all of the aforementioned conditioning functions remotely but requires a proprietary data terminal device.

It should be noted that all of these devices are dependent upon a test access circuit provided by the switch manufacturers known as the No Test Trunk (NTT) interface in conformance with the Local Switching System Generic Requirements (LSSGR) document published by Telcordia (formerly BellCore). The protocols for gaining metallic access to any subscriber line through this electromechanical interface are well known to those skilled in the art and available through published documents of Telcordia. The No Test Trunk interface is described in detail in TR-TSY 000536 (a Module of LSSGR, FR 64). This interface has been in the public domain since 1926 when it was first published in the Bell Laboratories Record.

Despite the foregoing, there is the need for apparatus and methods that enable more automated line testing and reporting so that field-obtained test data can be automatically and accurately obtained and transferred into a centralized database.

### SUMMARY OF THE INVENTION

The present invention enables a telephone technician to use a single test device, e.g., a microprocessor controlled field test device, to automatically and accurately validate the complete performance of a telephone subscriber loop from the originating equipment to the subscriber demarcation point without any human assistance at the central office (i.e., machine-to-machine communication occurs without the need for voice or other prompts to the field technician). The originating equipment subscriber loop or directory number under test is automatically identified and stored without any human intervention such that the No Test Trunk can be automatically used and test results can be automatically associated with the respective line record information. Data (e.g., the electronic serial number (ESN) of the field test device, the date/time of the testing, the test results data from the test set, and the subscriber's telephone number) can be collected and then transmitted in suitable manner (e.g., one or more data packets) and stored in non-volatile memory for collection by and/or transmission to a central host processing system. Although not limiting broader concepts of the present invention, particular aspects of the aforementioned collection and storage processes relate to the transmission of the data packets via several input/output (I/O) ports including Ethernet connectivity, a dial-up modem port, EIA/TIA-232E Serial Port or a standard POTS line utilizing DTMF signaling. The present invention also provides for modem or DTMF communication over the same pair of tip and ring wires.

The present invention provides a subscriber loop test data acquisition apparatus for a telephone network central office having a Class 5 or end-office switch, from a line side of which a plurality of subscriber loops extend, and to which a No Test Trunk is connected. The apparatus comprises a line interface configured to connect to the line side of the switch such that the subscriber loop test data acquisition apparatus is accessible through the switch by a field test device, connected to a selected one of the subscriber loops, dialing a directory number of the line switch assigned to the subscriber loop test data acquisition apparatus. The line interface includes a calling number delivery decoder that automatically responds, in response to the field test device dialing the directory number assigned to the subscriber loop test data acquisition apparatus and the subscriber loop test data acquisition apparatus responding thereto, to the switch transmitting the directory number assigned to the subscriber loop to which the field test device is connected. The subscriber loop test data acquisition apparatus can further comprise a No Test Trunk interface, configured to connect to the No Test Trunk, and a central processing unit configured to automatically operate with the line interface and the No Test Trunk interface such that said directory number is obtained and metallic access through the No Test Trunk is provided between the subscriber loop test data acquisition apparatus and the field test device automatically without human intervention when the subscriber loop test data acquisition apparatus is connected to the switch and the No Test Trunk and the field test device is connected to the subscriber loop and the field test device initiates a call to the subscriber loop test data acquisition apparatus. The apparatus can still further comprise a plurality of access ports, responsive to the central processing unit, through which to communicate with an operational support system of a telephone company. In one implementation, the plurality of access ports include a modem, configured to operate in an originate on answer mode and having an input connected to tip and ring lines of a telephone circuit, and a DTMF decoder having an input connected to the tip and ring lines, such that both the modem and the DTMF concurrently receive an incoming call placed over the tip and ring lines.

The present invention also provides a method of identifying a subscriber loop circuit to a test device connected to the subscriber loop. The method comprises: automatically detecting in a central office a call from a test device connected to a subscriber loop extending from the central office and having a directory number assigned thereto and automatically generating a calling number delivery transmission including the directory number for the subscriber loop; automatically responding to the calling number delivery transmission, including storing the directory number in memory; and automatically communicating the stored directory number to the calling test device.

The present invention also provides a subscriber loop test data collection method. This method comprises collecting in a public switched telephone network central office, without human intervention, electrical characteristics and transmission performance parameters of a subscriber loop under test from a field test device that has been connected to the subscriber loop and operated to measure the electrical characteristics and transmission performance parameters. Collecting preferably includes receiving the electrical characteristics and transmission performance parameters through metallic access provided by a No Test Trunk operated automatically in the central office by a loop responder using a directory number for the subscriber loop automatically stored in the loop responder in response to the field test device calling the loop responder over the subscriber loop. The collected electrical characteristics and transmission performance parameters can be transmitted to an operational support system via a corporate intranet or the Internet utilizing TCPIP protocol, or the public switched telephone network using ASCII protocol, or using tone signaling over a dial-up connection via the public switched telephone network.

The present invention can also be defined as an automated method of testing a tip and ring wire-pair subscriber loop extending between a telephone network central office and a subscriber, which method comprises: a) connecting a field test device to the tip and ring wires of the subscriber loop; b) calling with the field test device over the tip and ring wires a phone number assigned to a loop responder connected to a central office switch and to a No Test Trunk circuit in the central office; c) automatically in the loop responder receiving a calling number delivery transmission from the switch and automatically storing in the loop responder a directory number of the calling subscriber loop identified in the calling number delivery transmission; d) automatically using the stored directory number to cause the No Test Trunk to lift battery from the subscriber loop and to establish a metallic path between the loop responder and the subscriber loop; e) automatically conducting tests of the subscriber loop between the loop responder and the field test device using the metallic path through the No Test Trunk; and f) automatically transmitting test data obtained from the automatically conducted tests in the field test device through the No Test Trunk to the loop responder; and wherein at least steps c) through f) are performed sequentially without human intervention.

The present invention still further includes a method of detecting a call over a public switched telephone network, the method comprising coupling the call to both a modem and a DTMF decoder simultaneously and determining the method of call transport as either modem tone or dual tone multi-frequency using originate on answer protocol in the modem, thereby providing the caller with means to control the transport method.

Therefore, from the foregoing, it is a general object of the present invention to provide novel and improved apparatus and method of identifying a subscriber loop circuit to a test device connected to the subscriber loop, and novel and improved subscriber loop test data collection method, and novel and improved call detecting method. Other and further objects, features and advantages of the present invention will be readily apparent to those skilled in the art when the following description of the preferred embodiment is read in conjunction with the accompanying drawings.

### BRIEF DESCRIPTION OF THE DRAWINGS

FIG. 1 is a simplified block diagram of a system using the present invention.

FIG. 2 is a simplified flow chart for the operation for the implementation of FIG. 1.

FIG. 3 is a more detailed block diagram for implementing the system of FIG. 1.

FIG. 4 is a block diagram of one implementation for a loop responder of the present invention.

FIGS. 5A through 5G define a flow chart for an automated machine-to-machine sequence of operation for the loop responder of the present invention and a conventional field test device.

FIG. 6 is a schematic diagram of a dual signal responsive call answering circuit.

### DETAILED DESCRIPTION OF THE INVENTION

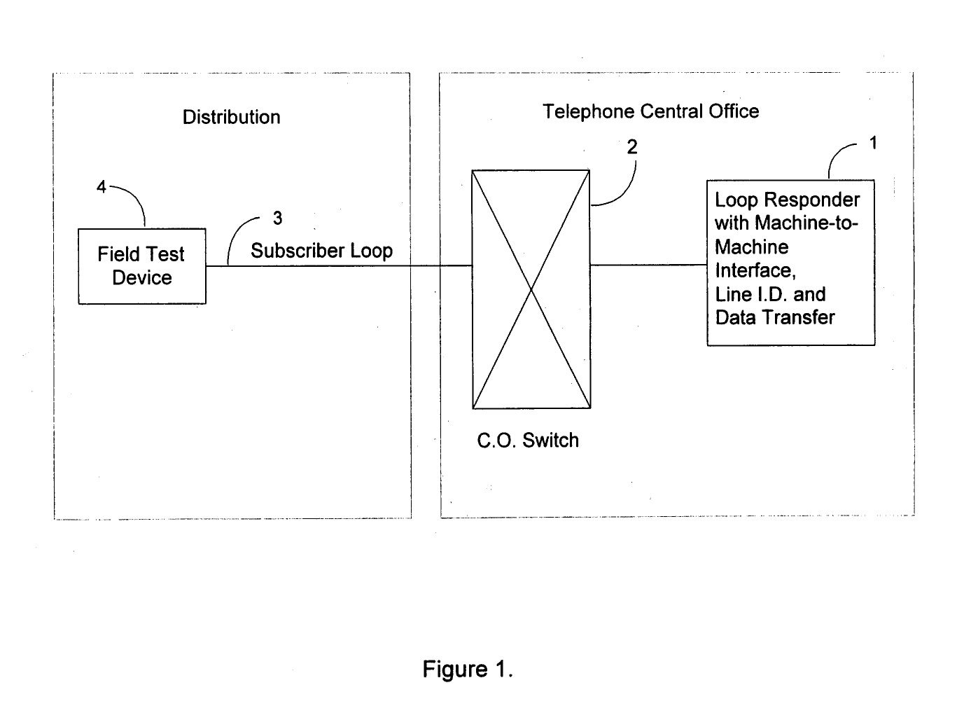

A subscriber loop test data acquisition apparatus, for use in a telephone network central office, implementing the present invention is identified in FIG. 1 as a loop responder 1. In accordance with the present invention, the loop responder 1 uses machine-to-machine interface whereby line identification, testing and data transfer between a field test device 4 and the loop responder 1 occur automatically (that is, without human intervention once automatic operation is selected at the field device). In use, the loop responder 1 connects to a designated port on the line side of a typical Class 5 or end-office switch 2 in a central office. A plurality of subscriber loops extend to phone company customers from the line side of the switch in known manner. One subscriber loop 3 is illustrated, and it is this line that is under test by the field test device 4, which device 4 can be of any suitable type used in the field by telephone technicians (such a device is typically microprocessor-controlled and one particular example is the PairChek II from Communications Manufacturing Company). The loop responder 1 is used to provide a variety of line conditioning functions for automatic measurement and analysis of the total performance of the subscriber loop 3. The loop responder 1 automatically identifies the directory number assigned to the subscriber line under test and stores test results obtained by the field test device 4 connected to the subscriber loop under test.

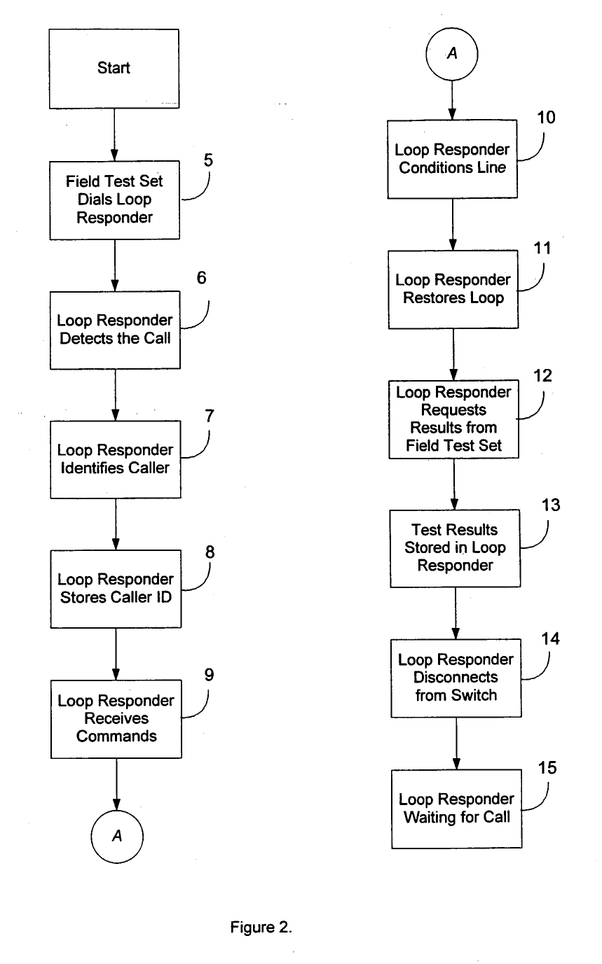

FIG. 2 illustrates a mechanized (i.e., automated) process implemented using the loop responder 1. The present invention is responsive to the stored-program control of the field test device 4. Under the control of such program, a microprocessor in the field test device 4 dials the directory number assigned via the central office switch 2 to the connected loop responder 1 (see block 5 in FIG. 2). If the loop responder 1 is not concurrently handling some predetermined maximum number of calls (e.g., three at one time), the loop responder 1 detects the call from the field test device 4 (block 6) and identifies the caller (block 7). The originating equipment's (OE's) directory number (that is, the directory number of the subscriber loop via which the field test device 4 is calling) is stored in memory in the loop responder 1 (block 8). The stored program in the field test device 4 requests the prescribed line conditioning required for measurements, and the loop responder 1 receives the commands (block 9) and conditions the line in response to each request (block 10). When the testing is complete, the loop responder 1 restores the subscriber loop (block 11) while maintaining the connection with the field test device 4. The loop responder 1 then requests the test results from the field test device 4 (block 12) and stores received test results in memory in the loop responder 1 for retrieval by an operational support system (block 13). The loop responder 1 then disconnects from the calling subscriber loop via the central office switch 2 (block 14) and returns to the idle state or “waiting for call” state (block 15).

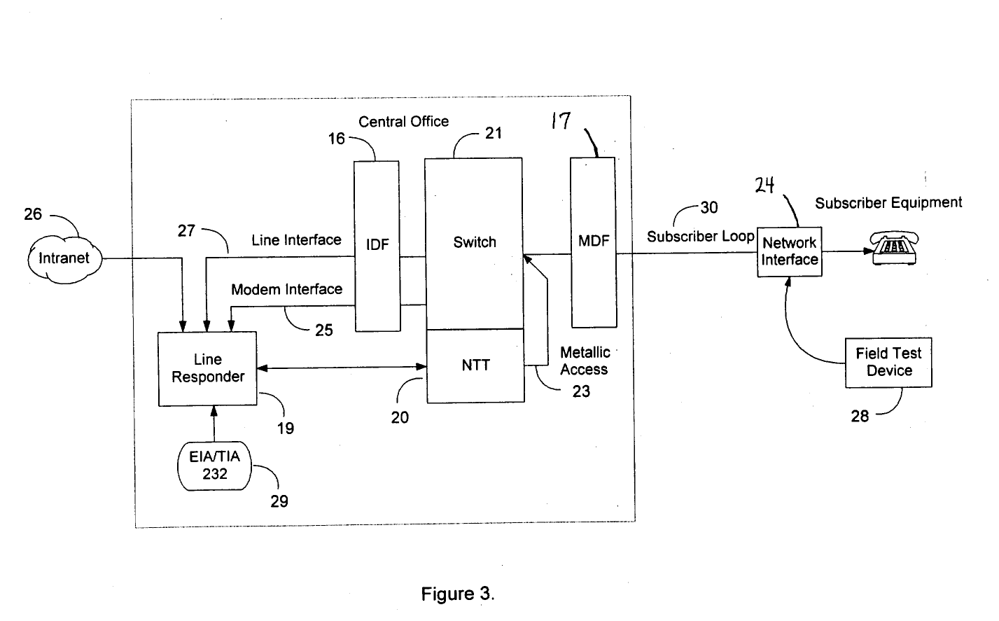

A more detailed implementation of the foregoing embodiment is illustrated in FIG. 3.

Referring to FIG. 3, a loop responder 19 (corresponding to loop responder 1 of FIG. 1) includes a housing that is designed to be affixed to the horizontal side of a typical Intermediate Distributing Frame (IDF) 16 of known type in a telephone central office such that in use the loop responder 19 is typically a fixed-installation, rather than field-portable, apparatus. Connections to this implementation are made utilizing distributing frame jumper wire and are terminated using industry standard wire-wrapping tools. Once the connections are made, the present invention is connected to a fuse panel providing −48 volts DC and is continuously powered.

Loop responder device 19 illustrated in FIG. 3 is also wired to a conventional No Test Trunk (NTT) circuit 20 of central office switch 21 (corresponding to central office switch 2 in FIG. 1). The NTT circuit 20 provides metallic access 23 to subscriber loop 30 (corresponding to loop 3 in FIG. 1), which is connected through a conventional Main Distributing Frame (MDF) 17. The subscriber loop 30 is shown as being under test by field test device 28 (corresponding to field test device 4 in FIG. 1). The field test device 28 can be connected at any suitable point along the loop 30 (one specific example is at the illustrated network interface 24).

A modem interface circuit 25 provides means through which to remotely upgrade the software in the loop responder 19 (such as, for example, using ASCII character set and Y-modem protocol on a call-in or call-out basis). The modem interface circuit 25 further provides an alternative path to retrieve test results data in the event of intranet 26 connectivity failure, which intranet 26 refers to, for example, an internal TCPIP protocol local area network within a telephone company's facilities as known in the art. Another feature of the modem interface circuit 25 is the access means to perform remote diagnostics of the loop responder 19 in the event of system lockup or any of a plurality of error messages from the loop responder 19.

Line interface circuits 27 connect to the intermediate distributing frame 16 of the central office switch to provide the initial means to connect the loop responder 19 with the field test device 28. The line interface 27 includes a Calling Number Delivery (CND) decoder that automatically responds to the switch 21 transmitting the directory number assigned to the subscriber loop to which the field test device is connected. This CND transmission from the switch 21 occurs in known manner when the field test device 28 dials the directory number assigned to the subscriber loop test data acquisition apparatus 19.

Local serial EIA/TIA 232 access port 29 provides means to perform diagnostics utilizing an industry standard laptop computer. This port further provides means to reload the system software or monitor activity in real time. For example, with a computer connected to this port 29 and terminal emulation enabled, a user can enter a predetermined command whereupon status messages are visible on the computer display.

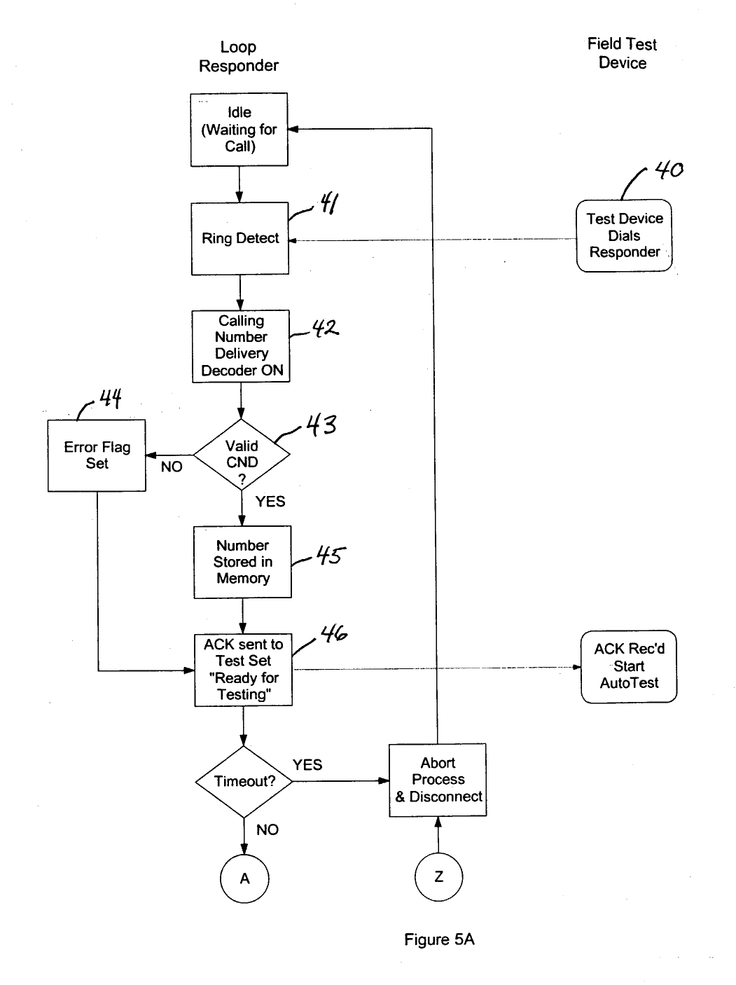

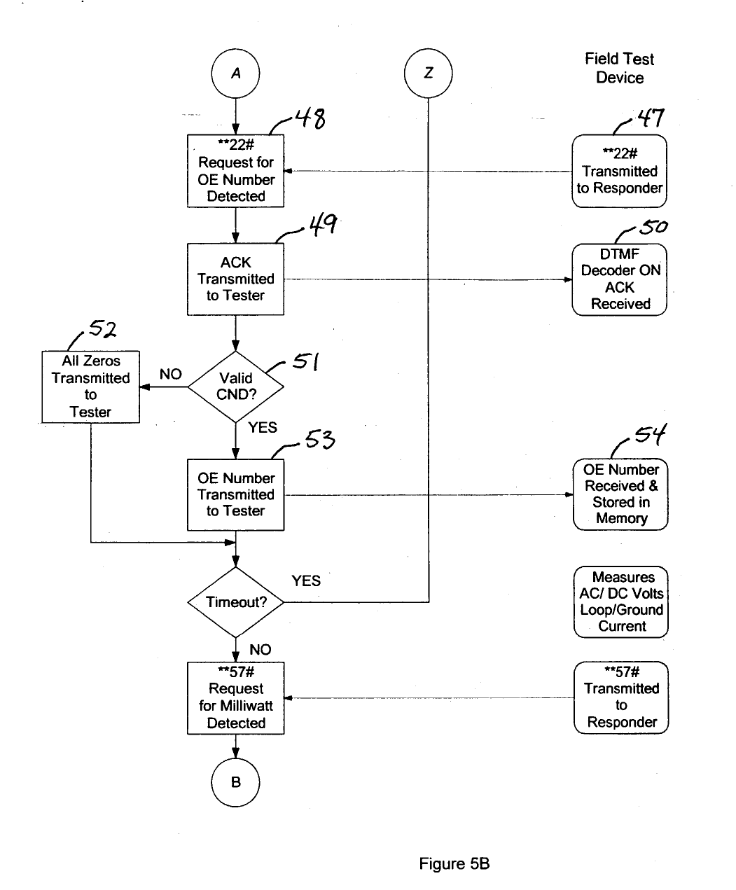

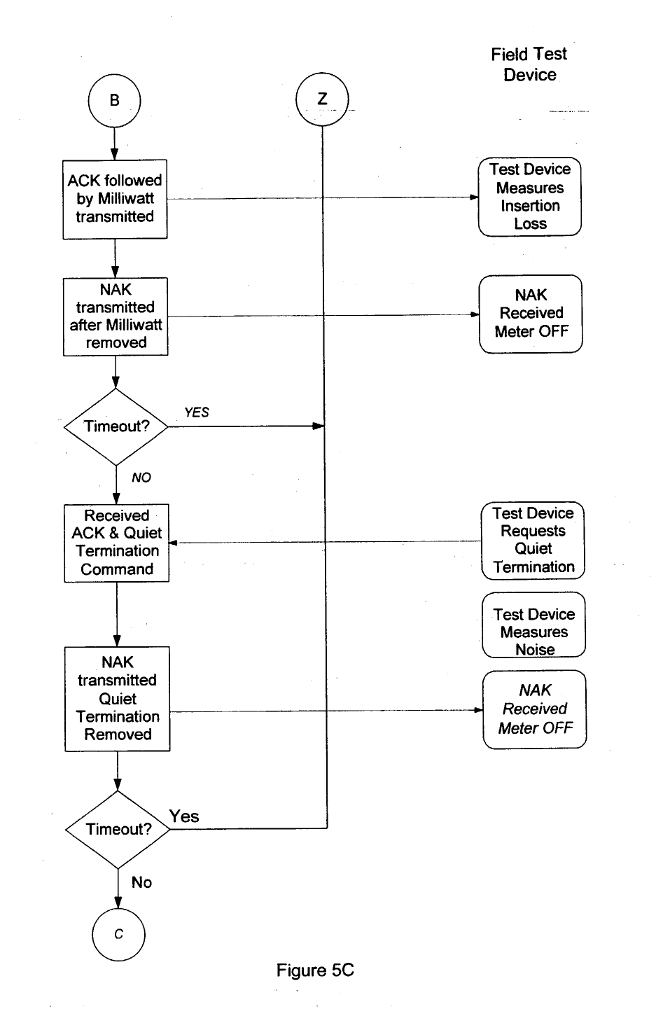

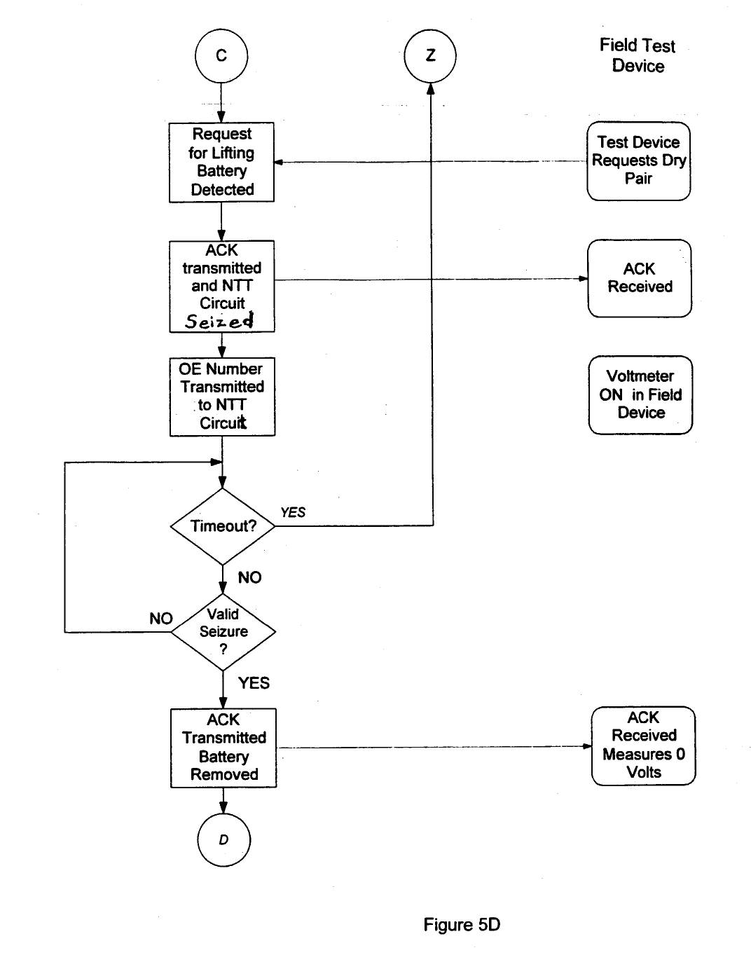

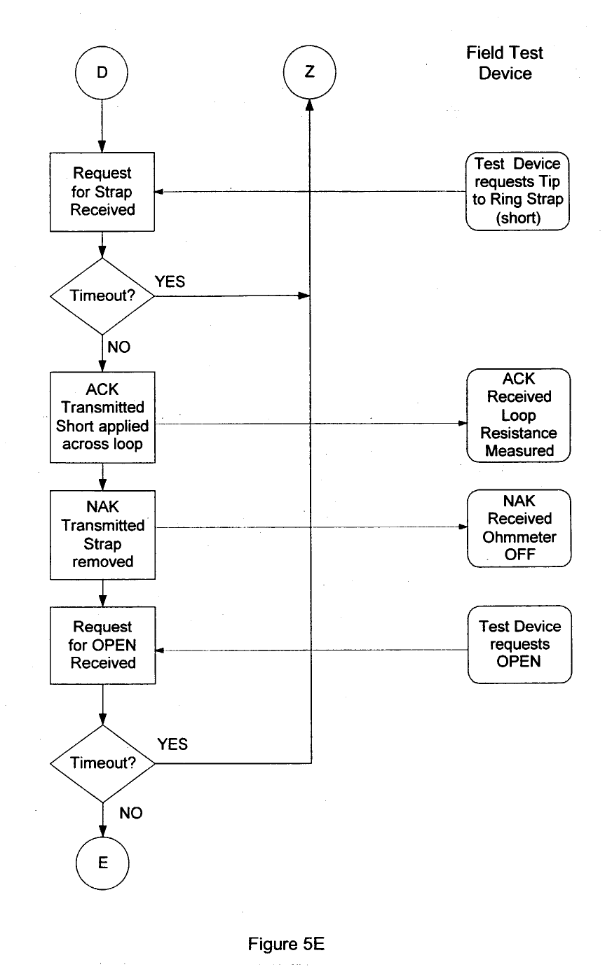

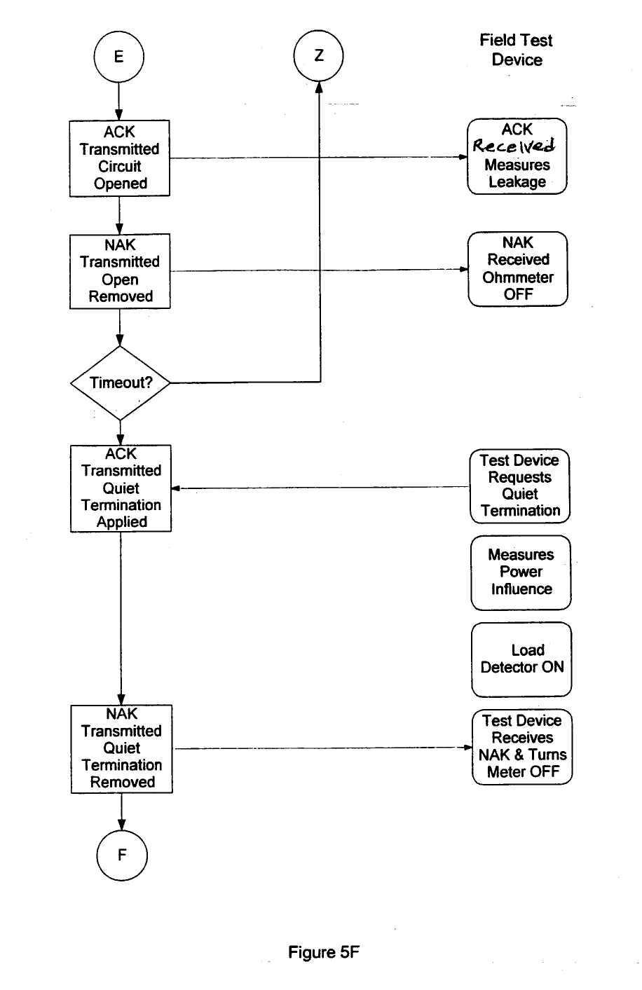

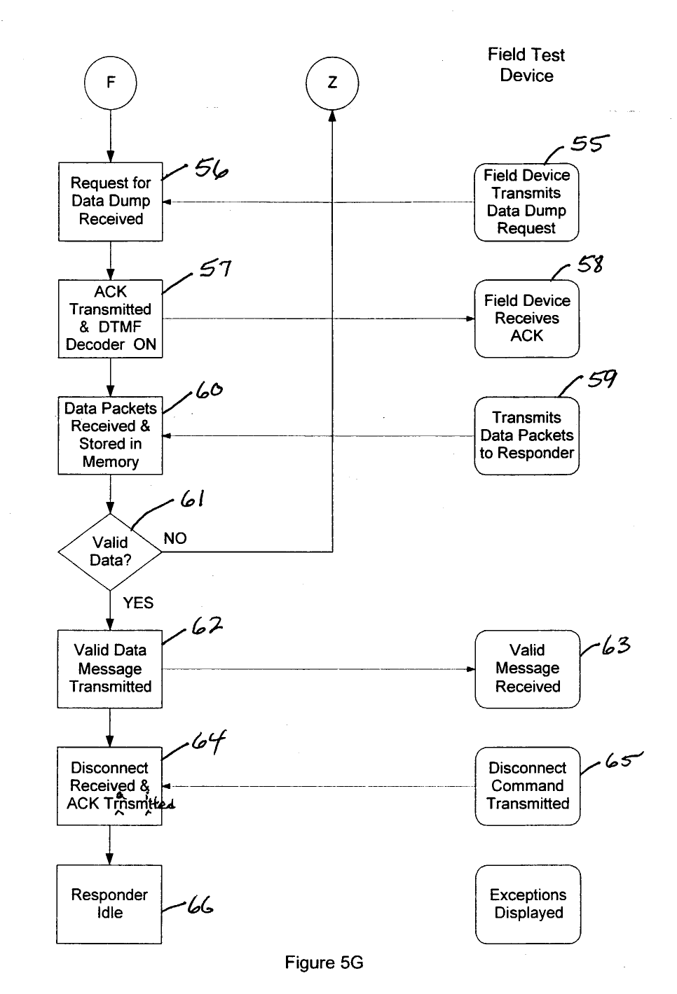

Although the particular loop responder 19 illustrated in FIG. 3 includes circuits to perform a number of functions useful in making specific tests from a field testing device, of especial interest to the present invention is the automatic configuration program by which the automatic routine exemplified in FIG. 5, for example, can be performed. That is, when automatic test mode is entered at the field test device 28, no further human interaction is needed for the loop responder 19 to automatically identify the calling subscriber loop, respond to test commands (e.g., DC, AC and transmission tests) from the field test device 28, and upload test results into the loop responder 19. Of further interest to the present invention is the ability to store the test results and transmit these to a host database system. In a particular implementation, test results are received from the field test device 28 in packets of 128 bytes and stored in random access memory (RAM) in the loop responder 19. A counter is employed in the loop responder 19 to register the number of packets received. When the number of packets received equals a predetermined number or a predetermined time (e.g., one hour) has elapsed, all stored packets are transmitted from the loop responder 19 to a host system of the telephone company. Such host system is of any suitable type, but typically includes the respective telephone company's system that maintains line records (i.e., the records for each subscriber loop); one example is a Loop Maintenance Operations System (LMOS).

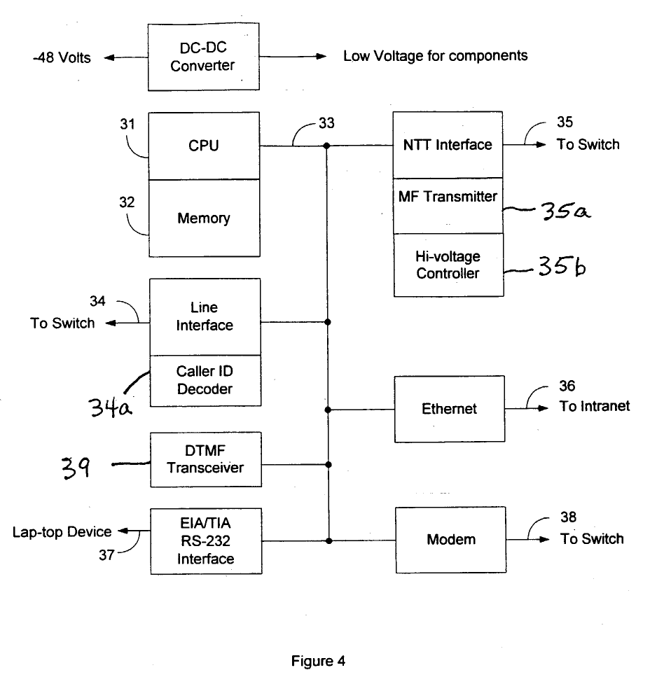

In the illustrated implementation of the loop responder 19 shown in FIG. 4, a Central Processing Unit (CPU) 31 with flash and random access memory 32 (e.g., an 8052 derivative processor with 128K of flash memory and 64K of RAM) is connected to a buss structure 33 providing means to control the ports associated with the device.

One or more line interface ports 34 are configured to connect to the originating equipment side of a typical telephone switching system via tip and ring terminals. These connections represent the input ports providing the means to access the loop responder from any subscriber loop associated with a specific switching system.

The calling number delivery (CND) decoder, or caller ID decoder, 34a is part of the line interface as shown in FIG. 4; this decoder is implemented using known technology to detect and decode a directory number transmitted by the switch in known manner when the field test device calls the loop responder. That is, when the field test device is connected to a central office port that is configured to transmit, toward the central office direction of the line side of the switch, an assigned 300 baud calling number delivery (CND) frequency shift keying (FSK) signal designating the respective calling subscriber loop, which automatically occurs in the switch in known manner between the first and second rings upon placing a call, the caller ID (or CND) decoder shown in FIG. 4 detects this, decodes the number and stores it in memory in the loop responder. The use of CND utilizes one of the CLASS Services features common to all North American Switching Machines, regardless of manufacturer. This interface is defined in Telcordia (formerly BellCore) Technical Requirements Document TR-NWT-000031, Calling Number Delivery (A Module of LSSGR, FR-64).

In the illustrated embodiment of FIG. 4, one or more NTT ports 35 are configured to connect to the No Test Trunk interface circuits associated with the specific switching system providing the means to acquire metallic access to the subscriber loop. The NTT circuit of the central office switch operates in known manner upon appropriate known command protocol from the loop responder. In the present invention, however, the appropriate command protocol signal (or signals) is generated automatically using the decoded CND number stored in the loop responder memory. This automatic control by the loop responder uses known technology to implement a multi-frequency (MF) transmitter 35a and high-voltage controller 35b through which commands are provided to the NTT to drop the battery of the respective subscriber loop and establish metallic access to it. Particularly, the MF transmitter uses 2-of-6 frequency encoding in conventional manner for NTT control communications, and the high-voltage controller operates in known manner with a digital loop carrier having pair gain test controller function.

Also incorporated in the loop responder 19 of FIG. 4 is an industry standard 10/100 Base T Ethernet port 36 configured such as to connect to a corporate LAN/Intranet hub at the central office providing means to communicate via intranet/internet to a centralized database where the performance summary is stored with the subscriber's line record as mentioned above.

A local access EIA/TIA 232 serial interface port 37 implemented with known technology can be interruptively connected to a laptop device for the purpose of performing diagnostics or loading software applications as mentioned above.

A further feature of the present invention includes a conventional modem 38 providing still other access into and out of the loop responder.

A dual tone multi-frequency (DTMF) transceiver 39 implemented using known technology interfaces/interprets between the DTMF format used in transmitting between the field test device and the loop responder and the digital format used by the cpu 31, whether such DTMF signaling occurs through the line interface port 34 or the NTT interface port 35.

Referring now to FIGS. 5A through 5G, a detailed operation of the implementation of the present invention shown in FIG. 4 will be described. This process of FIG. 5 preferably occurs automatically between the field test device and the loop responder without human intervention.

FIG. 5A shows that when a field test device calls the loop responder, the loop responder automatically detects in the central office a call from the test device connected to the subscriber loop extending from the central office and having a directory number assigned thereto. The ring detect occurs through the line interface 34 of FIG. 4. When ring is detected, the CND decoder 34a is turned on and it listens to receive a CND transmission from the switch. This should occur between the first and second rings. The loop responder determines validity for a received transmission by checking a checksum used in the known CND protocol. (See blocks 40, 41, 42 and 43 in FIG. 5A.)

If a valid CND number is not received, an error flag is set in the loop responder (block 44). If the directory number assigned to the calling subscriber loop is correct, it is stored in the loop responder (block 45). In either event, the loop responder notifies the field test device that it is ready for the subscriber loop testing (block 46). If no timeout has occurred, the automatic process continues as shown in FIG. 5B.

Referring to FIG. 5B, the field test device transmits **22# to the loop responder to have the directory number downloaded to the field test device (block 47). When the loop responder receives this command, as detected through the DTMF transceiver 39 in FIG. 4, an acknowledgement is sent to the field test device and either all zeroes (if the CND number was invalid) or the CND number (if valid) is transmitted in DTMF encoding to the field test device, where it is then also stored (see blocks 48-54).

Although not shown in FIG. 5, the loop responder also sends the CND number to the NTT 20 (FIG. 3) using conventional NTT protocol so that the NTT 20 in known manner disconnects the battery from the calling subscriber loop and establishes a metallic path directly between the loop responder and the subscriber loop. Further communications between the loop responder and the field test device occur through this direct metallic path rather than through the matrix of the switch 21 in FIG. 3. Both the aforementioned acquisition of the caller identification from the switch 21 and the instigation of the establishment of the metallic access via the NTT 20 occur automatically by means of the automated operation of the loop responder 19.

FIGS. 5B-5F continue with steps used in performing various automated line tests known in the art. These include configuring and testing for milliwatt, quiet termination, battery lift, shorts/loop resistance, open/leakage, and power influence, for example. These can be performed in conventional manner.

Once testing has occurred such that there is data at the field test unit, it is communicated to the loop responder using the subscriber loop test data collection method of the present invention. This comprises collecting in a telephone network central office, without human intervention, electrical characteristics and transmission performance parameters of a subscriber loop under test from a field test device that has been connected to the subscriber loop and operated to measure the electrical characteristics and transmission performance parameters. Referring to FIG. 5G, the field test device transmits a data dump request using DTMF signaling over the metallic access circuit (i.e., through the NTT) (block 55 in FIG. 5G). When acknowledgement has occurred as represented in FIG. 5G (blocks 56-58), the field test device of one particular implementation transmits the data in 128 byte packets of DTMF encoded numeric information in predetermined sequence separated by commas (blocks 59 and 60). Data validation occurs in the loop responder by using checksum verification (block 61). If valid data has been received, this is acknowledged and disconnect communications occur as represented in FIG. 5G (blocks 62-66). If valid data is not received, up to a predetermined maximum number of retries can occur.

Once data is stored in the loop responder, it can be transferred to a facility within the telephone network for further processing or use. In the illustrated implementation, this occurs when a predetermined condition occurs (e.g., complete transmission from the field test device or passage of predetermined time period). The illustrated implementation is versatile as to this in that collected electrical characteristics and transmission performance parameters can be transmitted via the Ethernet port and the corporate intranet using TCPIP protocol, or via the modem and the Internet utilizing TCPIP protocol, or via the modem and the Public Switched Telephone Network (PSTN) using ASCII protocol, or using tone (DTMF) signaling over a dial-up connection via the PSTN.

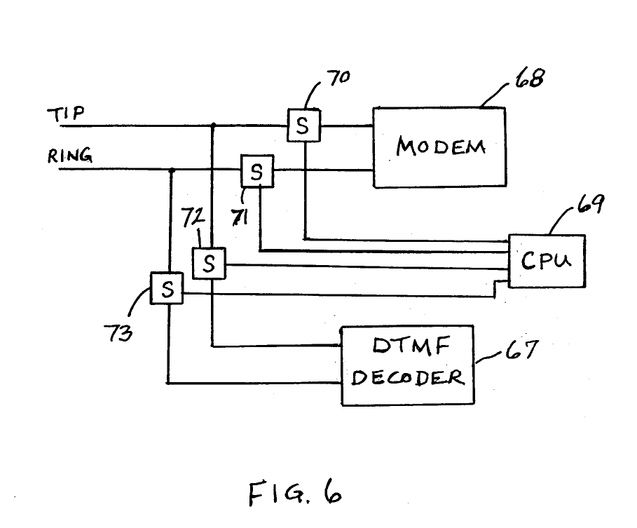

Another feature that can be used in the loop responder to facilitate upload of data or other communication with a telephone company host system is to have the loop responder automatically detect and switch to accommodate an incoming call in either modem or DTMF protocol. Referring to FIG. 6, a DTMF decoder 67 and a modem 68 (such as corresponding to those described above) are switchably connected to the same incoming tip and ring lines. When an incoming call occurs, the modem 68 is operated in a known originate on answer mode so that the calling end sees a quiet audio coupling at the loop responder. If a DTMF signal is sent by the caller and detected by the DTMF decoder 67 in the loop responder, the decoder 67 signals the cpu 69 to disconnect the modem 68 from the tip and ring lines (such as by opening relay switches 70 and 71). If, instead, the modem 68 detects answer tone from the caller, the modem 68 signals the cpu 69 to disconnect the DTMF decoder 67 (such as by opening relay switches 72 and 73). The foregoing occurs automatically. Thus, this provides a method of detecting a call from a host database collection system over the PSTN and coupling the call audio signal to a modem and a DTMF decoder device simultaneously and to determine the method of transport using originate on answer protocol, thereby providing the host system with the means to control the transport method. This method is not limited to use with the loop responder or system of FIGS. 1-5 or the other aspects of the present invention.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

What is claimed is:

1. A subscriber loop test data acquisition apparatus for a telephone network central office having a Class 5 or end-office switch, from a line side of which a plurality of subscriber loops extend, and to which a No Test Trunk is connected, the apparatus comprising a line interface configured to connect to the line side of the switch such that the subscriber loop test data acquisition apparatus is accessible through the switch by a field test device, connected to a selected one of the subscriber loops, dialing a directory number of the line switch assigned to the subscriber loop test data acquisition apparatus; wherein the line interface includes a calling number delivery decoder that automatically responds, in response to the field test device dialing the directory number assigned to the subscriber loop test data acquisition apparatus and the subscriber loop test data acquisition apparatus responding thereto, to the switch transmitting the directory number assigned to the subscriber loop to which the field test device is connected.

2. A subscriber loop test data acquisition apparatus as defined in claim 1, further comprising a No Test Trunk interface, configured to connect to the No Test Trunk, and a central processing unit configured to automatically operate with the line interface and the No Test Trunk interface such that said directory number is obtained and metallic access through the No Test Trunk is provided between the subscriber loop test data acquisition apparatus and the field test device automatically without human intervention when the subscriber loop test data acquisition apparatus is connected to the switch and the No Test Trunk and the field test device is connected to the subscriber loop and the field test device initiates a call to the subscriber loop test data acquisition apparatus.

3. A subscriber loop test data acquisition apparatus as defined in claim 2, further comprising a plurality of access ports, responsive to the central processing unit, through which to communicate with an operational support system of a telephone company.

4. A subscriber loop test data acquisition apparatus as defined in claim 3, wherein the plurality of access ports include a modem, configured to operate in an originate on answer mode and having an input connected to tip and ring lines of a telephone circuit, and a DTMF decoder having an input connected to the tip and ring lines, such that both the modem and the DTMF concurrently receive an incoming call placed over the tip and ring lines.

5. A subscriber loop test data acquisition apparatus as defined in claim 1, further comprising a modem, configured to operate in an originate on answer mode and having an input connected to tip and ring lines of a telephone circuit in the central office, and a DTMF decoder having an input connected to the tip and ring lines, such that both the modem and the DTMF concurrently receive an incoming call placed over the tip and ring lines to retrieve data stored in the subscriber loop test data acquisition apparatus.

6. A method of identifying a subscriber loop circuit to a test device connected to the subscriber loop, comprising:
automatically detecting in a central office a call from a test device connected to a subscriber loop extending from the central office and having a directory number assigned thereto and automatically generating a calling number delivery transmission including the directory number for the subscriber loop;
automatically responding to the calling number delivery transmission, including storing the directory number in memory; and
automatically communicating the stored directory number to the calling test device.

7. Subscriber loop test data collection method, comprising collecting in a public switched telephone network central office, without human intervention, electrical characteristics and transmission performance parameters of a subscriber loop under test from a field test device that has been connected to the subscriber loop and operated to measure the electrical characteristics and transmission performance parameters.

8. Subscriber loop test data collection method as defined in claim 7, wherein collecting includes receiving the electrical characteristics and transmission performance parameters through metallic access provided by a No Test Trunk operated automatically in the central office by a loop responder using a directory number for the subscriber loop automatically stored in the loop responder in response to the field test device calling the loop responder over the subscriber loop.

9. Subscriber loop test data collection method as defined in claim 7, further comprising transmitting the collected electrical characteristics and transmission performance parameters to an operational support system via a corporate intranet.

10. Subscriber loop test data collection method as defined in claim 7, further comprising transmitting the collected electrical characteristics and transmission performance parameters to an operational support system via the Internet utilizing TCPIP protocol.

11. Subscriber loop test data collection method as defined in claim 7, further comprising transmitting the collected electrical characteristics and transmission performance parameters to an operational support system via the public switched telephone network using ASCII protocol.

12. Subscriber loop test data collection method as defined in claim 7, further comprising transmitting the collected electrical characteristics and transmission performance parameters to an operational support system using tone signaling over a dial-up connection via the public switched telephone network.

13. Subscriber loop test data collection method as defined in claim 7, wherein collecting the electrical characteristics and transmission performance parameters from the field test device includes using tone signaling via a test trunk facility of the public switched telephone network central office.

14. An automated method of testing a tip and ring wire-pair subscriber loop extending between a telephone network central office and a subscriber, comprising:
a) connecting a field test device to the tip and ring wires of the subscriber loop;
b) calling with the field test device over the tip and ring wires a phone number assigned to a loop responder connected to a central office switch and to a No Test Trunk circuit in the central office;
c) automatically in the loop responder receiving a calling number delivery transmission from the switch and automatically storing in the loop responder a directory number of the calling subscriber loop identified in the calling number delivery transmission;
d) automatically using the stored directory number to cause the No Test Trunk to lift battery from the subscriber loop and to establish a metallic path between the loop responder and the subscriber loop;
e) automatically conducting tests of the subscriber loop between the loop responder and the field test device using the metallic path through the No Test Trunk; and
f) automatically transmitting test data obtained from the automatically conducted tests in the field test device through the No Test Trunk to the loop responder;
and wherein at least steps c) through f) are performed sequentially without human intervention.

15. A method of detecting a call over a public switched telephone network, comprising coupling the call to both a modem and a DTMF decoder simultaneously and determining the method of call transport as either modem tone or dual tone multi-frequency using originate on answer protocol in the modem, thereby providing the caller with means to control the transport method.
